(19) United States
(12) Patent Application Publication
(10) Pub. No.: US 2026/0308945 A1
(43) Pub. Date: Oct. 8, 2026

(54) MOTOR VEHICLE LOCK ARRANGEMENT FOR A CLOSURE ELEMENT OF A MOTOR VEHICLE

(71) Applicant: Brose Schließsysteme GmbH & Co. Kommanditgesellschaft, Wuppertal (DE)

(72) Inventors: Abdelali EI-Hamoumi, Wuppertal (DE); Frank Horschgen, Solingen (DE); Markus Kothe, Velbert (DE); Tatjana Schmidt, Leverkusen (DE)

(21) Appl. No.: 19/540,042

(22) Filed: Feb. 13, 2026

(30) Foreign Application Priority Data
Feb. 18, 2025 (DE) 102025106022.3

(51) Int. Cl. E05B 77/26; E05B 81/06; E05B 81/20; E05B 85/26

(52) U.S. Cl. CPC E05B 77/26; E05B 81/06; E05B 81/20; E05B 85/26

(57) ABSTRACT

A motor vehicle lock arrangement for a motor vehicle, wherein the motor vehicle lock arrangement includes a motor vehicle lock, a control unit, a motor, a first drivetrain, a second drivetrain, and a sensor assembly having at least one sensor, wherein the motor drives the first drivetrain when the motor generates motor movements in a first motor direction starting from a starting range, wherein the motor drives the second drivetrain when the motor generates motor movements starting from the starting range in a second motor direction, wherein the control unit is configured to control the motor to trigger a first function of the motor vehicle lock arrangement via the first drivetrain and a second function of the motor vehicle lock arrangement via the second drivetrain, and wherein a sensor of the sensor assembly generates a sensor signal when the motor reaches a first starting position in the starting range.

### CROSS-REFERENCE TO RELATED APPLICATION

This application claims priority pursuant to 35 U.S.C. 119 to German Patent Application No. 102025106022.3, filed Feb. 18, 2025, which application is incorporated herein by reference in its entirety.

### FIELD OF THE INVENTION

The present invention relates to a motor vehicle lock arrangement for a closure element of a motor vehicle according to the preamble of Claim 1 and to a closure element arrangement having a closure element and a motor vehicle lock arrangement according to claim 13 assigned to the closure element.

### BACKGROUND OF THE INVENTION

The term “closure element” is to be understood broadly in this case. It includes, for example, a tailgate, a trunk lid, a hood, a side door, a cargo area flap, a window pane, a lifting roof or the like of a motor vehicle. The following focuses on the area of application of a side door of a motor vehicle. A closure element can be assigned a motor vehicle lock arrangement having a motor vehicle lock which serves to hold the closure element in a closed position and to secure it against opening. Motor vehicle locks are to provide more and more convenience functions, in particular pushing open and/or pulling closed, at the lowest possible cost and with the smallest possible installation space. A motor vehicle lock usually has a locking mechanism with a lock latch and at least one pawl.

When pushed open, the closure element is moved into a gap position. The gap position is a position that lies beyond an open position of the motor vehicle lock. The open position, in turn, is the position that is reached when the motor vehicle lock is opened, i.e., specifically when the pawl is lifted. Due to the door sealing pressure and any spring preload of the lock latch that may exist, the closure element is pushed open slightly by lifting the pawl and the motor vehicle lock reaches the open position. However, in particular with modern handleless side doors, a user should be able to open the side door by reaching into the gap between the motor vehicle body and the side door. The gap in the open position is not sufficient for comfortably reaching therein. A push-open arrangement is therefore provided, which pushes the side door, or more generally the closure element, open even further. To push open the closure element into the gap position, the push-open arrangement has a push-open element and a motor for moving the push-open element.

When being pulled closed, the lock latch is pulled closed by a motor, generally from a pre-closing position to a main closing position, i.e., moved in its closing direction. This means that the user does not have to close the closure element completely but can move it into the pre-closing position with little effort. Pulling it closed can also be advantageous in combination with a motor-driven closure element since the drive of the closure element then does not have to apply the force required to bring the closure element into the main closing position against the door sealing pressure. Drives for closure elements are generally not designed for such a combination of short travel and high torque.

It is known from the prior art to use one motor for a plurality of functions of the motor vehicle lock arrangement. Two functions can be assigned to one motor direction or to opposite motor directions. If opposite motor directions are used, each motor direction can be assigned a drivetrain. Starting from a starting range, a movement in one of the motor directions then adjusts one of the drivetrains and an opposite movement adjusts the other drivetrain. The drivetrain that is not in use can be partially or completely decoupled during this time. After a function is triggered via a drivetrain, the motor is reset to the starting range by the motor being operated in the opposite direction. It is then possible to trigger the other function via the other drivetrain.

One problem with such an arrangement is that both drivetrains have tolerances and the starting range must be large enough that when one drivetrain is reset, the other drivetrain is not already activated and the corresponding function triggered. It is therefore also evident that the starting range, which would regularly be referred to as the starting position, really is a range. Because the arrangement must be designed for the worst sum of tolerances, it can happen that after the motor is reset it will be at the edge of the starting range and must first pass through the starting range before the other function is triggered. This results in a delay when a function is triggered. To make matters worse, even a sensor for detecting the starting range has tolerances in installation and detection. Even these tolerances exacerbate the problem. One solution is to provide particularly low tolerances. However, this increases costs and makes it difficult to use in the drivetrains power transmission means that are inherently particularly subject to tolerances, such as a flexible pulling means.

Generally, a motor vehicle lock arrangement for a closure element of a motor vehicle is assumed, wherein the motor vehicle lock arrangement comprises a motor vehicle lock, a control unit, a motor, a first drivetrain, a second drivetrain, and a sensor assembly with at least one sensor, wherein the motor drives the first drivetrain when the motor generates motor movements in a first motor direction starting from a starting range, wherein the motor drives the second drivetrain when the motor generates motor movements in a second motor direction opposite the first motor direction, wherein the control unit is configured to drive the motor to trigger a first function of the motor vehicle lock arrangement via the first drivetrain and a second function of the motor vehicle lock arrangement via the second drivetrain, and wherein a sensor of the sensor assembly generates a first sensor signal when the motor reaches a first starting position in the starting range.

The challenge here lies in allowing higher tolerances and/or using fewer components in a cost-effective design of the motor vehicle lock arrangement with one motor for two functions assigned to opposite motor directions, while still keeping the delay low when at least one of the functions is triggered.

### SUMMARY OF THE INVENTION

A motor vehicle lock arrangement for a locking element of a motor vehicle, wherein the motor vehicle lock arrangement comprises a motor vehicle lock, a control unit, a motor, a first drivetrain, a second drivetrain, and a sensor assembly having at least one sensor, wherein the motor drives the first drivetrain when the motor generates motor movements in a first motor direction starting from a starting range, wherein the motor drives the second drivetrain when the motor generates motor movements starting from the starting range in a second motor direction, wherein the control unit is configured to control the motor to trigger a first function of the motor vehicle lock arrangement via the first drivetrain and a second function of the motor vehicle lock arrangement via the second drivetrain, and wherein a sensor of the sensor assembly generates a sensor signal when the motor reaches a first starting position in the starting range. It is proposed that a sensor of the sensor arrangement generates a second sensor signal, different from the first sensor signal, when the motor reaches a second starting position, different from the first starting position, in the starting range.

The invention is based on the object of designing and developing the known motor vehicle lock arrangement in such a way that further optimization is achieved with regard to the above challenge.

The above object is achieved by the features of the characterizing part of claim 1.

The essential consideration is that different starting positions can be provided in the starting range in order to shorten the path when a function is triggered. This means the starting range does not need to be traversed completely if the other function was triggered beforehand.

Specifically, it is proposed that a sensor in the sensor arrangement generates a second sensor signal that is different from the first sensor signal when the motor reaches a second starting position in the starting range that is different from the first starting position. It is noted that a starting position also has a spatial extent and therefore also covers a range. However, the term “starting position” is used to distinguish it linguistically from the “starting range.” The starting range includes both starting positions.

In an embodiment according to claim 2, it is provided that a starting position of a function, in particular the starting positions, is or are assigned to the functions, and that the other starting position is passed through when the other function is reset. This allows the path to be shortened for at least one function, in particular both functions, when the function is triggered.

Claim 3 provides that the control system stops the motor in response to the first and/or second sensor signal. In this way, different stop positions of the motor can be realized.

Particularly interesting are embodiments according to claim 4, wherein at least one drivetrain has a flexible pulling means. Flexible pulling means, in particular flexible pulling means with low flexural strength, are often more susceptible to tolerances, particularly changes in length due to tension, aging, or temperature changes. To actuate a drivetrain out of the starting range, it may customarily be necessary to tension the flexible pulling means before power is transmitted. This can cause a significant delay. This can be reduced by the two starting positions.

Claim 5 specifies a preferred embodiment of the motor vehicle lock and preferred functions assigned to the drivetrains.

In an embodiment according to claim 6, a pushing-open movement is assigned to the first drivetrain. In an embodiment according to claim 7, the first drivetrain is additionally or alternatively assigned a lifting of the pawl. Preferably, the pushing-open and lifting movements are accordingly performed in a synchronized manner via a common flexible pulling means. In an embodiment according to claim 8, a pulling-closed movement is assigned to the second drivetrain. The pulling-closed movement is temporally/functionally independent of the pushing-open and lifting movements and is therefore preferably assigned to the other motor direction.

Claim 9 provides that the two sensor signals originate from the same sensor. For this reason, compared to a variant with one sensor for a starting position, no additional sensor needs to be added.

A sensor counter-element that interacts with the sensor can be assigned to the push-open element according to claim 10.

Other possible sensors are the subject-matter of claim 11.

Claim 12 relates to preferred embodiments of the flexible pulling means, which may in each case be a strap. A sheathless embodiment, in particular in contrast to a Bowden cable, also increases flexibility and deflectability. A strap can be more stable than a rope and at the same time cost less.

According to a further teaching according to claim 13, which has independent significance, a locking element arrangement is claimed comprising a locking element and a proposed motor vehicle lock arrangement assigned to the locking element.

Reference may be made to all the statements relating to the proposed motor vehicle lock arrangement.

### BRIEF DESCRIPTION OF THE DRAWINGS

In the following, the invention is explained in more detail with reference to a drawing that represents just one exemplary embodiment. In the drawing:

FIG. 1A shows a motor vehicle with a motor vehicle lock;

FIG. 1B shows a schematic explanation of the basic idea of various embodiments;

FIG. 2A shows the proposed motor vehicle lock in the first starting position;

FIG. 2B shows the proposed motor vehicle lock in the first starting position;

FIG. 3A shows the second starting position;

FIG. 3B shows the first starting position;

FIG. 3C shows a pawl in the release position;

FIG. 4A shows the motor vehicle lock in the main locking position;

FIG. 4B shows the motor vehicle lock in the pre-closing position;

FIG. 4C shows a pulling-closed process.

### DETAILED DESCRIPTION OF THE INVENTION

The proposed motor vehicle lock arrangement 1 is assigned to a closure element 3 that is movably coupled to a motor vehicle body 2. The closure element 3 is here, and preferably, a side door of a motor vehicle 4. However, the proposed motor vehicle lock arrangement 1 can also be applied to all other conceivable closure elements 3 of a motor vehicle 4. These include, in particular, rear doors, tailgates, trunk lids, or hoods. Here, and preferably, the closure element 3 designed as a side door can be pivoted about a substantially vertical pivot axis. However, in principle, the closure element 3 can also be designed in the manner of a sliding door.

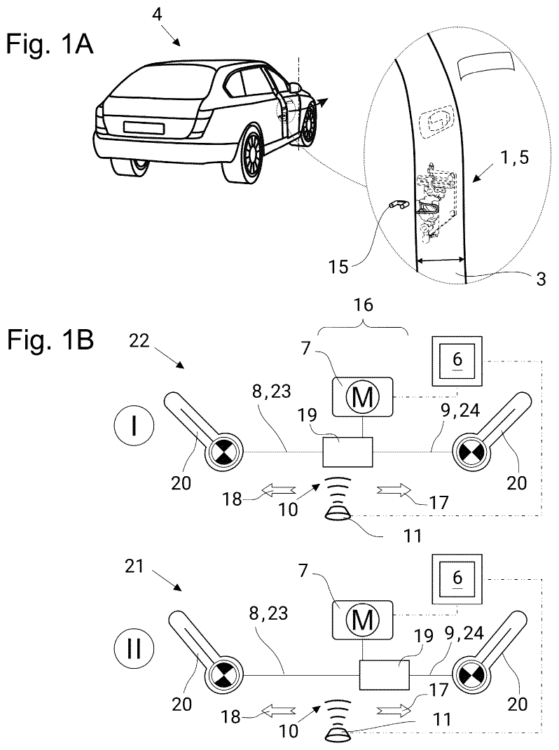

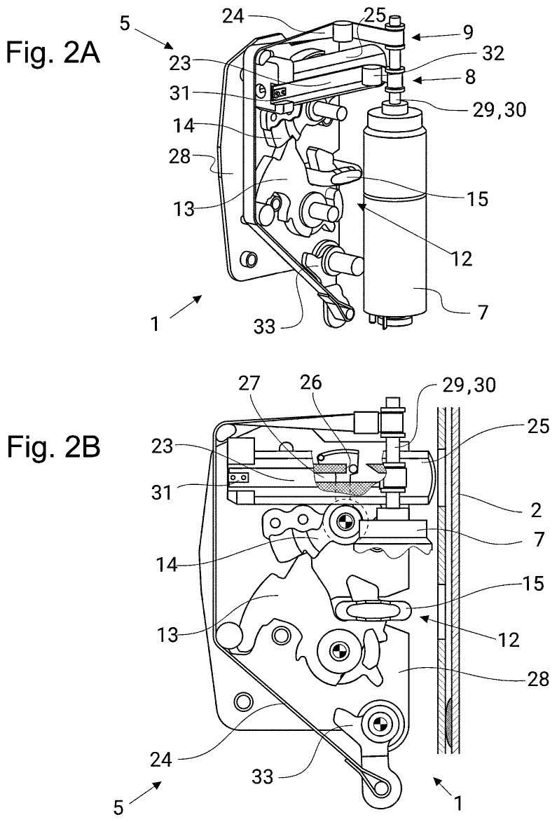

The motor vehicle lock arrangement 1 is shown in the installed state in FIG. 1A. The motor vehicle lock arrangement 1 comprises a motor vehicle lock 5, shown in detail in FIG. 2A and FIG. 2B, a control unit 6 shown schematically and, here and preferably, as part of the motor vehicle lock 5, a motor 7, a first drivetrain 8, a second drivetrain 9 and a sensor assembly 10 with at least one sensor 11. The motor 7 can be designed as an electric motor, to which here and preferably not shown in detail a gear mechanism is connected downstream. The drivetrains 8, 9 each have one or more power transmission elements to transmit motor movements.

In the installed state, the motor vehicle lock 5 is arranged on the locking element 3. Alternatively, it may also be provided that the motor vehicle lock 5 is arranged on the motor vehicle body 2. The motor vehicle lock 5 is equipped with a locking mechanism 12 with a lock latch 13 and a pawl 14. FIG. 2A and FIG. 2B shows two views of the motor vehicle lock 5 in a main locked position.

The lock latch 13 can be brought from an open position by a counterclockwise movement in FIG. 2A or FIG. 2B in a closing direction into at least one closing position, in this case into a main closing position and into a pre-closing position. In the closing positions, the lock latch 13 engages with a locking part 15 or the like for transmitting door holding forces. The door holding forces act on the closure element 3 in its closing direction in order to counteract opening of the closure element 3.

Conversely, the lock latch 13 can be moved from the closing positions into the open position by a movement in the opening direction, in which open position the lock latch 13 releases the locking part 15 in the opening direction of the closure element 3.

It can be seen from the drawings that the pawl 14 is assigned to the lock latch 13, and that the pawl 14 can be brought into a locking position in which it locks the lock latch 13 in a closing position against pivoting in the opening direction of the lock latch 13. In addition, the pawl 14 can be lifted here, and preferably by a motor into a release position, in which it releases the lock latch 13 in its opening direction so that the lock latch 13 can pivot into its open position.

While the pawl 14 is spring-preloaded on the lock latch 13, the lock latch 13, also spring-preloaded, is pushed into its open position. The spring arrangements required for this purpose are not shown here for the sake of clarity.

The motor 7 drives the first drivetrain 8 when the motor 7 generates motor movements in a first motor direction 17 starting from a starting range 16. The motor 7 also drives the second drivetrain 9 when the motor 7 generates motor movements starting from the starting range 16 in a second motor direction 18 opposite the first motor direction 17. The control unit 6 is configured to control the motor 7 in order to trigger a first function of the motor vehicle lock arrangement 1 via the first drivetrain 8 and a second function of the motor vehicle lock arrangement 1 via the second drivetrain 9.

FIG. 1B schematically shows how the motor 7 acts on two drivetrains 8, 9 by adjusting an output element 19—which is not relevant in any more detail at the schematic level—for example, to the right and left. To trigger the relevant function, a pulling on the corresponding drivetrain 8, 9 is provided here. The two drivetrains 8, 9 are assigned a functional element 20, designed here as a lever, which is also not relevant at a schematic level and which serves as an example of a respective function. In FIG. 1B, the motor 7, and thus indirectly the output element 19, are arranged in the starting range 16 in both the first and second representations.

Now it is also provided that a sensor 11 of the sensor arrangement 10 generates a first sensor signal when the motor 7 reaches a first starting position 21 in the starting range 16. In FIG. 1B in the first representation I, the output element 19 is detected by the sensor 11.

It is essential that a sensor 11 of the sensor arrangement 10 generates a second sensor signal which is different from the first sensor signal when the motor 7 reaches a second starting position 22 in the starting range 16 which is different from the first starting position 21. In FIG. 1B, in the second representation II it can be seen that the output element 19 is not detected by the sensor 11, meaning that the sensor 11 generates a different sensor signal from that in the first illustration I. The advantage of this arrangement is evident from the fact that in the first representation I in FIG. 1B, where the motor 7 is in the second starting position 22, the right-hand function can be triggered more quickly than in the second representation II, where the left-hand function can be triggered more quickly.

The motor directions and the starting range 16 are provided with reference numerals only in FIG. 1B. In the other figures, these are difficult to represent due to the rotary movement, but are present in an analogous form and can be identified by the elements downstream of the motor 7 in terms of drive configuration.

It is therefore the case here and preferably that the first starting position 21 is arranged, starting from the second starting position 22, in the direction of the first motor direction 17.

Preferably, as explained with reference to FIG. 1B, the motor vehicle lock arrangement 1 is configured to trigger the first function from the first starting position 21 and/or to trigger the second function from the second starting position 22. In principle, it is also conceivable to use one of the starting positions 21, 22 only for stopping and then always proceed to the other starting position 21, 22, from which both functions are then triggered.

Furthermore, it is here and preferably and in accordance with the explanations for FIG. 1B the case that when the first drivetrain 8 is reset by motor movements in the second motor direction 18 in the direction of the starting range 16, the motor 7 passes through the first starting position 21 and stops in the second starting position 22, and/or that when the second drivetrain 9 is reset by motor movements in the first motor direction 17 in the direction of the starting range 16, the motor 7 passes through the second starting position 22 and stops in the first starting position 21.

Generally speaking, it can also be provided that the control unit 6 receives the first sensor signal and the second sensor signal, and that the control unit 6, in response to the first sensor signal and/or the second sensor signal, controls the motor 7, in particular stops it. The sensor signal is therefore causal for the control action. As will be explained later, it is possible that, in addition to the presence of the sensor signal, other conditions must be met. However, it is also possible that the presence of the sensor signal is the only condition for stopping.

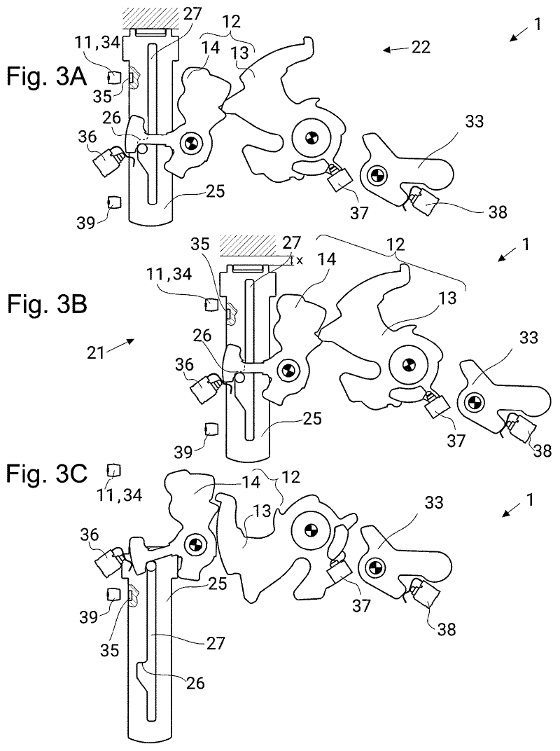

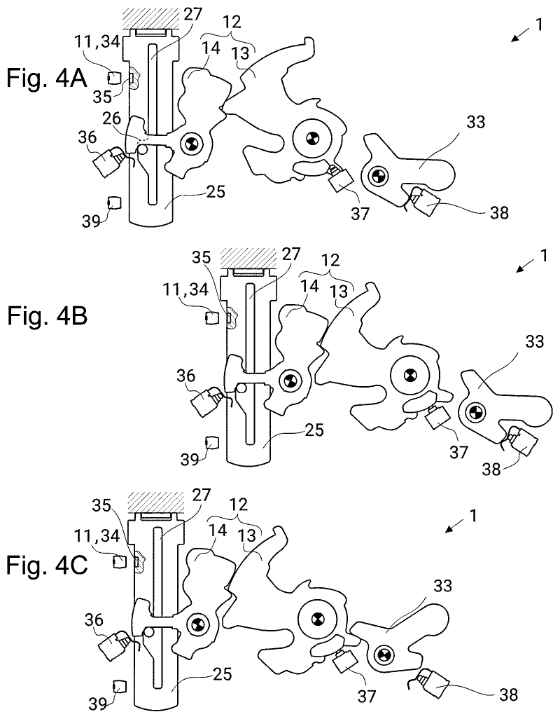

FIGS. 2A, 2B, 3A, 3B, 3C, 4A, 4B, and 4C now show a motor vehicle lock arrangement 1, wherein FIGS. 3A-3C and 4A-4C show reduced views. This motor vehicle lock arrangement 1 implements the basic concept described with reference to FIG. 1B.

Before discussing the individual functions in detail, it is worth noting that here and preferably the first drivetrain 8 for transmitting the motor movements to a functional element 20 for triggering the function assigned to the first drivetrain 8 comprises a first flexible pulling means 23, in particular a flexible pulling means with low flexural strength, and/or that the second drivetrain 9 for transmitting the motor movements to a functional element 20 for triggering the function assigned to the second drivetrain 9 comprises a second flexible pulling means 24, in particular a flexible pulling means with low flexural strength.

The first flexible pulling means 23 and/or the second flexible pulling means 24 typically and preferably have a longitudinal direction along which the movements transmitted by the relevant flexible pulling means 23, 24 are transmitted and are flexible transversely to the longitudinal direction.

In general, the term “flexible” in connection with the pulling means is understood to mean that they are flexible orthogonally to the pulling direction. In the pulling direction, the corresponding flexible pulling means 23, 24 is preferably stable in such a way that the pulling forces that occur do not cause any relevant change in the length of the flexible pulling means 23, 24. Nevertheless, due to temperature changes, aging, production tolerances and the like, it can happen that a flexible pulling means is temporarily or permanently longer than specified. These tolerances can be considerably higher compared to rigid drivetrains 8, 9.

It is thus the case that when one of the flexible pulling means 23, 24 is pulled, it must first be tensioned, which results in a loss of time. This tensioning is done in advance, here and preferably by the different starting positions.

In detail, it is provided here and preferably that the motor vehicle lock 5 has a lock 12 with a lock latch 13 and a pawl 14. In a motor vehicle lock 5, the drivetrains 8, 9 can be used for functions such as central locking. However, here and preferably at least two of the functions “lifting the pawl,” “pulling the latch closed” and “pushing open the locking element” are divided between the first drivetrain 8 and the second drivetrain 9.

In the following, the push-open function is considered first. It is here, and preferably, the case that the motor vehicle lock arrangement 1 has a push-open arrangement for pushing the closure element 3 into a gap position. The push-open arrangement has a push-open element 25, which is here and preferably linearly movable and in particular designed as a slide, for pushing the closure element 3 into the gap position. The function “pushing the closure element open” is then a movement of the closure element 3 into the gap position.

The push-open element 25 is supported here and preferably on the motor vehicle body 2 when it pushes the closure element 3 into the gap position. The function of the push-open element 25 can be seen from FIG. 2B. If the push-open element 25 is moved linearly to the right, it pushes away against the motor vehicle body 2 and thus pushes the closure element 3 open. A user can reach into an engagement gap created in the gap position and can manually open the closure element 3 further.

Usually, a gap of less than 10 mm, preferably of approximately 6 mm, remains between the closure element 3 and the motor vehicle body 2 in the opening direction of the closure element 3 when the lock latch 13 is in the pre-closing position. This gap is thus just of such a size that a user's hand cannot reach behind the gap, which would be associated with a considerable risk of pinching.

It is generally the case that the pre-closing position of the closure element 3 is located between the main closing position and the gap position of the closure element 3. This means that the engagement gap resulting from the gap position of the closure element 3 is larger than the aforementioned gap between the closure element 3 and the motor vehicle body 2, which gap corresponds to the pre-closing position. Preferably, the gap width of the engagement gap is greater than 18 mm and more preferably greater than 22 mm. In a particularly preferred embodiment, the gap width of the engagement gap is between approximately 26 mm and approximately 31 mm. These values have proven to be advantageous in particular for the user's hand reaching behind the engagement gap.

For performing the function “pushing the closure element open,” the motor 7 here and preferably generates motor movements in the first motor direction 17 which generate pulling movements of the first flexible pulling means 23, whereby the first flexible pulling means 23 moves the push-open element 25 in a push-open direction of the push-open element 25 and thus pushes the closure element 3 into the gap position. During the push-open process, the first flexible pulling means 23 is here and preferably pulled, whereby the first flexible pulling means 23 pulls on the push-open element 25 and moves it in the direction of the motor vehicle body 2. A maximum push-open force of the push-open element 25 is here and preferably at least 800 N, and more preferably at least 1000 N.

It can be seen that here and preferably the push-open direction of the push-open element 25 is a linear direction. Additionally, or alternatively, it is here and preferably the case that the push-open element 25 is formed separately from the lock latch 13. A stroke of the push-open element 25 and thus of the first flexible pulling means 23 can be at least 30 mm, preferably at least 40 mm, more preferably at least or approximately 50 mm. Preferably, the stroke is at most 150 mm, more preferably at most 100 mm.

Particularly with regard to FIG. 2B, FIGS. 3A-3C and FIGS. 4A-4C, it is provided here and preferably that for performing the function “lifting the pawl,” the motor 7 generates motor movements in the first motor direction 17, which generate pulling movements of the first flexible pulling means 23, whereby the first flexible pulling means 23 moves the pawl 14 into an opening direction and thus lifts the pawl 14. Accordingly, it is preferably the case that the lifting and the pushing-open movements take place in a mechanically synchronized manner. This can be seen in FIGS. 3A-3C. It is preferably the case that the push-open element 25 transmits a movement to the pawl 14 for lifting the pawl 14 during the “pushing the closure element open” function, wherein the push-open element 25 preferably has a driving contour 26, by means of which the push-open element 25 lifts the pawl 14.

Accordingly, it is preferably the case that the driving contour 26 acts directly on the pawl 14 or directly on an element rigidly connected to the pawl 14. It is particularly preferably the case that the pawl 14 has a metal core and a plastics component rigidly connected to the metal core, and that the driving contour 26 acts directly on the plastics component.

In FIG. 3C, for example, it can be seen that here and preferably the push-open element 25 holds the pawl 14 in a release position after the pawl 14 has been lifted. This allows the lock latch 13 and the locking part 15 to be moved freely. Preferably, the push-open element 25 only releases the pawl 14 from the release position when the push-open element 25 is returned in a reversing process, in particular by the motor 7. Depending on its design, such a function is known as a snow load function.

After the lifting movement, the pawl 14 runs here and preferably in a free run slot 27 of the push-open element 25, so that the push-open element 25 can be adjusted further.

With regard to FIG. 4A, FIG. 4B, and FIG. 4C, it is provided here and preferably that, for performing the function “pulling the lock latch closed,” the motor 7 generates motor movements in the second motor direction 18, which generate pulling movements of the second flexible pulling means 24, whereby the second flexible pulling means 24 moves the lock latch 13 in a closing direction and thus pulls the lock latch 13 closed, in particular from the pre-closing position and/or into the main closing position. During the pulling-closed movement, a stroke of the second flexible pulling means 24 can be 20 to 40 mm, here and preferably approximately 25 mm.

As at least the perspective representation suggests, the motor 7 and/or the push-open element 25 can form a structural unit with the motor vehicle lock 5 that as such can be handled individually. This structural unit can then be mounted as such. Preferably, the motor vehicle lock 5 and the motor 7 and/or the motor vehicle lock 5 and the push-open element 25 are carried by a common carrier, in particular a carrier plate. The common carrier may, for example, be a carrier of a door module.

In a preferred embodiment, the motor vehicle lock 5 has a housing 28, on or in which the motor 7 and/or the push-open element 25 is/are arranged. The housing 28 can of course also be provided separately. Here and preferably the first flexible pulling means 23 and/or the second flexible pulling means 24 are arranged completely or with at least more than 50% of their length in the housing 28. Such an arrangement is particularly compact and makes use of the flexibility with which the motor 7 can be positioned. In addition, it may be provided that the push-open element 25 is moved out of the housing 28 of the motor vehicle lock 5 during the pushing-open movement.

It can be seen from FIG. 2A and FIG. 2B that here and preferably the first flexible pulling means 23 and the second flexible pulling means 24 are coupled to the motor 7 in such a way that, when motor movements are generated in the first motor direction 17, the first flexible pulling means 23 is wound on and the second flexible pulling means 24 is unwound. When motor movements in the second motor direction 18 are generated, the situation is correspondingly reversed.

It is preferable that during their movements the first flexible pulling means 23 and/or the second flexible pulling means 24 are wound onto and unwound from a winding shaft 29, in particular the same winding shaft 29. Preferably, the first flexible pulling means 23 and/or the second flexible pulling means 24 are wound in multiple layers onto the winding shaft 29. Furthermore, the winding shaft 29 is preferably coaxial with a motor shaft 30 of the motor 7; in particular, the winding shaft 29 is the motor shaft 30 itself or an extension of the motor shaft 30 or an attachment to the motor shaft 30. It is conceivable that the winding radius of the flexible pulling means 23, 24 is the same or different. Different winding shafts 29 are also conceivable.

Furthermore, it is provided here and preferably that the first flexible pulling means 23 is fastened directly to the push-open element 25 at a fastening point 31. Preferably, the first flexible pulling means 23 runs from the fastening point 31 along the push-open element 25 in the push-open direction of the push-open element 25 and is subsequently preferably deflected at least once. For this purpose, a deflection pulley 32 is provided.

The drawings show that the second flexible pulling means 24 here and preferably is fastened to a closing lever 33 for the lock latch 13. Alternatively, the second flexible pulling means 24 can be fastened to the lock latch 13. Preferably, the second flexible pulling means 24 is deflected at least once, preferably multiple times. The second flexible pulling means 24 and/or the first flexible pulling means 23 can be deflected by an element, in particular a pulley, fixed to the housing. This is particularly easy to implement. Here and preferably the second flexible pulling means 24 is twisted between two deflections. This demonstrates the high degree of flexibility when the flexible pulling means 23, 24 is guided through the motor vehicle lock 5. Additionally, or alternatively, torsion may also be provided for the first flexible pulling means 23.

As can also be seen in FIG. 2A and FIG. 2B, when one of the flexible pulling means 23, 24 is being wound on, the other is being unwound. Accordingly, this other flexible pulling means 23, 24 is pre-wound in the starting range 16 sufficiently to be able to be unwound far enough. A guide for unwinding one or both of the flexible pulling means 23, 24 may be provided, which guide in particular prevents each flexible pulling means 23, 24 from assuming uncontrolled positions during unwinding. The guide can, for example, be provided laterally of the flexible pulling means 23, 24 so that unwinding is guided, preferably in a reproducible manner. Additionally, or alternatively, a strap tensioner may be provided for one or both of the flexible pulling means 23, 24. The strap tensioner tensions the flexible pulling means 23, 24 during unwinding and may be provided, for example, by the leg of a spring, which is preferably also used for other purposes. In this way, each flexible pulling means 23, 24 is also reproducibly guided.

It is therefore evident that the two starting positions 21, 22 allow the relevant flexible pulling means 23, 24 to be under greater tension than would be the case with only one starting position 21, 22. This reduces the trigger time of the relevant function.

From FIG. 1B it can generally be seen that the sensor arrangement 10 can have a central sensor 34 which generates the first sensor signal and the second sensor signal. Here and preferably the central sensor 34 is the previously mentioned sensor 11. Preferably, the central sensor 34 has exactly two switching states, in this case actuated and not actuated, the switching of which defines the first sensor signal and the second sensor signal. This central sensor 34 is shown in FIGS. 3A-3C and 4A-4C. The central sensor 34 is here and preferably assigned to the pressure element 25 and can be designed as a Hall sensor. The central sensor 34 thus detects the starting positions 21, 22 indirectly via the push-open element 25.

Furthermore, it is provided here and preferably that the push-open element 25 has a sensor counter-element 35, in particular a sensor contour or a magnet, the interaction of which with the central sensor 34 defines the starting positions 21, 22.

FIGS. 3A-3C and 4A-4C show the relevant states of the vehicle lock 5 with respect to the central sensor 34 and other sensors.

Accordingly, it is provided here and preferably that the sensor arrangement 10 has a pawl sensor 36 for detecting a raised or lowered position of the pawl 14, and/or that the sensor arrangement 10 has a latch sensor 37 for detecting a main latch or a pre-latch or an open position of the latch 13, and/or that the sensor arrangement 10 has a closing lever sensor 38 for detecting a home position of the closing lever 33, and/or that the sensor arrangement 10 has a push-open sensor 39 for detecting an end position of the push-open element 25 assigned to the gap position.

With reference to these preferred sensors, it can now be seen that in FIG. 3A the motor vehicle lock 5 is arranged in the second starting position 22. In the transition to FIG. 3B, the motor vehicle lock 5 changes to the first starting position 21. Thereupon, by further adjusting the push-open element 25, the pawl 14 can be lifted and then the locking element 3 can be opened. The push-open sensor 39 can be used to detect when the pushing-open movement should be stopped. The push-open element 25 is then reset until the second starting position 22 is reached and identically FIG. 4A. Reopening would now experience a certain delay, as the first starting position 21) would have to be reached first. This can be accepted in exceptional cases. However, this is usually followed by a pulling-closed process, which is illustrated in FIGS. 4A-4C. A common sensor counter-element 35 can be provided for the central sensor 34 and the push-open sensor 39.

The states of the locking mechanism 12 are represented by the lock latch sensor 37 or two lock latch sensors 37 and the pawl sensor 36. This allows the pulling-closed process to be not only started but also stopped.

The closing lever sensor 38 can also be omitted here if required. This is because, after the pulling-closed movement, the motor 7 is operated again in the first motor direction 17, which is how the closing lever sensor 38 is reset and the second starting position is reached. This reaching cannot be detected by the central sensor 34, as it is continuously activated during the pulling-closed process, since the push-open element 25 is positioned at a stop. However, if the motor 7 continues to operate in the first motor direction 17 due to the lack of a shutdown, the first flexible pulling means 23 will be tensioned and the push-open element 25 moved. This allows the first starting position to be reached and the motor 7 here and preferably to be switched off. The closing lever sensor 38 can therefore be used as a redundancy. Alternatively, no closing lever sensor 38 is provided and the central sensor 34 is used to stop the motor 7 from resetting after the pulling-closed movement. The motor 7 is now ready to initiate a renewed lifting of the pawl 14 from the first starting position without delay.

Generally speaking, it can be provided that the resetting of the motor 7 after the pulling-closed movement is terminated when the motor 7, as here, reaches the first starting position 21 or the second starting position 22, and/or that no sensor 11 is assigned to the closing lever 33, and/or that the resetting of the motor 7 after the pulling-closed movement is terminated when the central sensor 34 changes its switching state. Starting from FIG. 4C, in which the pulling-closed movement is completed, the resetting and after the pulling-closed movement here in the first starting position 21 according to FIG. 3B is completed, whereby the second starting position 22 according to FIG. 3A and FIG. 4A is passed through. The resetting process after the pushing-open movement proceeds in reverse from FIG. 3C via FIG. 3B to FIG. 3A.

In general, it is the case here and preferably that the first flexible pulling means 23 and/or the second flexible pulling means 24 are a strap and/or are sheathless. A sheath, such as that in a Bowden cable, reduces the flexibility of the flexible pulling means 23, 24 but increases its resistance to external influences. A strap can also be flexibly placed around multiple corners and have a high level of stability.

Preferably, the first flexible pulling means 23 and/or the second flexible pulling means 24 have a width that is at least 1.5 times, preferably at least 4 times, more preferably at least 8 times, the thickness of the corresponding flexible pulling means 23, 24. Here and preferably the thickness of the first flexible pulling means 23 and/or of the second flexible pulling means 24 is between 0.5 mm and 1.5 mm, here mm, and/or the width is between 6 mm and 14 mm, preferably between 8 mm and 12 mm, here 10 mm. The width and thickness are orthogonal to the longitudinal direction. Additionally, or alternatively, it may be provided that the first flexible pulling means 23 and/or the second flexible pulling means 24 have an oval or rectangular cross-section. The cross section is also to be considered orthogonally to the longitudinal direction. The first flexible pulling means 23 and/or the second flexible pulling means 24 can be made of a textile material. The strap is preferably woven.

According to a further teaching, a locking element arrangement is proposed with a locking element 3 and a proposed motor vehicle lock arrangement 1 assigned to the locking element 3.

1. A motor vehicle lock arrangement for a locking element of a motor vehicle, wherein the motor vehicle lock arrangement comprises a motor vehicle lock, a control unit, a motor, a first drivetrain, a second drivetrain and a sensor assembly having at least one sensor, wherein the motor drives the first drivetrain when the motor generates motor movements in a first motor direction starting from a starting range, wherein the motor drives the second drivetrain when the motor generates motor movements starting from the starting range in a second motor direction opposite the first motor direction, wherein the control unit is configured to control the motor in order to trigger a first function of the motor vehicle lock arrangement via the first drivetrain and a second function of the motor vehicle lock arrangement via the second drivetrain, and, wherein a sensor of the sensor arrangement generates a first sensor signal when the motor reaches a first starting position in the starting range, wherein a sensor of the sensor arrangement generates a second sensor signal different from the first sensor signal when the motor reaches a second starting position in the starting range different from the first starting position.

2. The motor vehicle lock arrangement according to claim 1, wherein the motor vehicle lock arrangement is configured to trigger the first function from the first starting position and/or to trigger the second function from the second starting position, and in that, when the first drivetrain is reset by motor movements in the second motor direction toward the starting range, the motor passes through the first starting position and stops in the second starting position, and/or in that when the second drivetrain is reset by motor movements in the first motor direction toward the starting range, the motor passes through the second starting position and stops in the first starting position.

3. The motor vehicle lock arrangement according to claim 1, wherein the control unit receives the first sensor signal and the second sensor signal, and in that the control unit controls the motor, in particular stops it, in response to the first sensor signal and/or the second sensor signal.

4. The motor vehicle lock arrangement according to claim 1, wherein the first drivetrain for transmitting the motor movements to a functional element for triggering the function assigned to the first drivetrain comprises a first flexible pulling means, in particular a flexible pulling means with low flexural strength, and/or in that the second drivetrain for transmitting the motor movements to a functional element for triggering the function assigned to the second drivetrain comprises a second flexible pulling means, in particular a flexible pulling means with low flexural strength.

5. The motor vehicle lock arrangement according to claim 1, wherein the motor vehicle lock has a locking mechanism with a latch and a pawl, preferably in that at least two of the functions “lifting the pawl,” “pulling the latch closed” and “pushing the locking element open” are distributed between the first drivetrain and the second drivetrain.

6. The motor vehicle lock arrangement according to claim 1, wherein the motor vehicle lock arrangement has a push-open arrangement for pushing the closure element into a gap position, in that the push-open arrangement has a push-open element for pushing the closure element into the gap position, and in that the function “pushing the closure element open” is the movement of the closure element into the gap position, and in that, for performing the function “pushing the closure element open,” the motor generates motor movements in the first motor direction, which generate in particular pulling movements of the first flexible pulling means, as a result of which the first flexible pulling means moves the push-open element in a push-open direction of the push-open element and thus pushes the closure element into the gap position.

7. The motor vehicle lock arrangement according to claim 5, wherein for performing the function “lifting the pawl,” the motor generates motor movements in the first motor direction, which generate, in particular, pulling movements of the first flexible pulling means, as a result of which the first flexible pulling means moves the pawl in an opening direction and thus lifts the pawl, preferably in that, during the function “pushing the closure element open,” the push-open element transmits a movement to a pawl for lifting the pawl, preferably in that the push-open element has a driving contour, by means of which the push-open element lifts the pawl.

8. The motor vehicle lock arrangement according to claim 5, wherein the motor for performing the function “pulling the lock latch closed” generates motor movements in the second motor direction, which generate in particular pulling movements of the second flexible pulling means, as a result of which the second flexible pulling means moves the lock latch in a closing direction and thus pulls closed the lock latch closed, in particular from a pre-closing position and/or into a main closing position.

9. The motor vehicle lock arrangement according to claim 1, wherein the sensor arrangement has a central sensor which generates the first sensor signal and the second sensor signal, preferably in that the central sensor has exactly two switching states, the switching of which defines the first sensor signal and the second sensor signal.

10. The motor vehicle lock arrangement according to claim 9, wherein the push-open element has a sensor counter-element, in particular a sensor contour or a magnet, the interaction of which with the central sensor defines the starting positions.

11. The motor vehicle lock arrangement according to claim 1, wherein the sensor arrangement has a pawl sensor for detecting a raised or a lowered position of the pawl, and/or in that the sensor arrangement has a latch sensor for detecting a main latch or a pre-latch or an open position of the latch, and/or in that the sensor arrangement has a closing lever sensor for detecting a home position of the closing lever, and/or in that the sensor arrangement has a push-open sensor for detecting an end position of the push-open element assigned to the gap position.

12. The motor vehicle lock arrangement according to claim 4, wherein the first flexible pulling means and/or the second flexible pulling means is/are a strap and/or sheathless, preferably in that the first flexible pulling means and/or the second flexible pulling means have a width that is at least 1.5 times, preferably at least four times, more preferably at least eight times, as large as the thickness of the corresponding flexible pulling means, and/or in that the first flexible pulling means and/or the second flexible pulling means have an oval or rectangular cross-section.

13. A locking element arrangement comprising a locking element and a motor vehicle lock arrangement assigned to the locking element according to claim 1.
